(19) United States
(12) Patent Application Publication
(10) Pub. No.: US 2005/0169342 A1
(43) Pub. Date: Aug. 4, 2005

(54) DFB grating with dopant induced refractive index change

(75) Inventors: Rick William Glew, Ontario (CA); David Alexander MacQuistan, Ontario (CA); Ian Woods, Ontario (CA); John Kenton White, Ontario (CA)

Correspondence Address: LAUBSCHER SEVERSON, 1160 SPA RD, SUITE 2B, ANNAPOLIS, MD, 21403, US

(73) Assignee: Bookham Technology PLC, Abingdon (GB)

(21) Appl. No.: 10/976,073

(22) Filed: Oct. 28, 2004

Related U.S. Application Data
(60) Provisional application No. 60/515,415, filed on Oct. 30, 2003.

(51) Int. Cl. H01S 3/08

(52) U.S. Cl. 372/96; 372/102

(57) ABSTRACT

To make a grating substructure in semiconductor material for use in a DFB laser, a first layer of semiconductor material is doped at a first doping concentration. A second layer of the semiconductor material is formed over the first layer. The second layer is doped higher concentration than the first layer and sufficiently different to change the refractive index of the semiconductor material. A third layer doped at a concentration comparable with the first layer is formed over the second layer. An etch is performed through a mask to form spaced etched regions extending at least through the second and third layers. Then a further layer of the semiconductor material doped at a doping concentration comparable the first and third layers is overgrown on the wafer. This results in a composite layer of the semiconductor material doped at a low doping concentration containing spaced islands of the semiconductor material doped with a dopant at a high doping concentration and having a different refractive index from the composite layer. The semiconductor material is preferably silicon-doped InP.

### CROSS REFERENCE TO RELATED APPLICAION

This application claims the benefit under 35 USC 119(e) of prior U.S. provisional application No. 60/515,415, filed Oct. 30, 2003, the contents of which are incorporated herein by reference.

### FIELD OF THE INVENTION

The invention relates to the field of photonics, and in particular to DFB (Distributed Feedback) lasers. The invention has particular utility in optical communication systems employing WDM (Wavelength Division Multiplexing).

### BACKGROUND OF THE INVENTION

The Distributed FeedBack (DFB) laser and Distributed Bragg Reflector (DBR) laser have emerged as the method of choice for providing single-frequency semiconductor lasers for WDM systems.

In a DFB laser, a Bragg grating, formed either within or close to the active region, is provided to suppress multiple longitudinal modes and enhance a single mode. The most popular forms of grating are the loss grating index grating and the index grating. The loss grating, as its name implies, relies on absorption by the grating elements to create the grating. The index grating relies on the change in refractive index of the optical medium and is preferred since, unlike the absorption grating, does not result in loss of energy. The optical medium is typically InP with InGaAsP is used for an index grating and InGaAs used for a loss grating. The operation of the index grating relies on the difference in refractive index between InP and InGaAs(P). However, the presence of InGaAs(P) causes numerous manufacturing problems, which result in a relatively poor yield device.

The cross section of a typical DFB laser is shown schematically in FIG. 1. This consists of an n-InP substrate, an n-InP buffer layer, an n-InP layer, a multiple quantum well (MQW) light-emitting active layer, and a p-InP layer. The grating, which in this case in an index grating, is placed on the n-side, under the active MQW (Multiple Quantum Well) layer. The grating consists of a periodic array of islands of material (InGaAs(P)) with refractive index n₂ buried in a material (InP) with a different refractive index n₁.

A major problem with using both InGaAsP and InGaAs is that they are difficult to overgrow. Typically the overgrowth is performed in an MOCVD (Metal Organic Chemical Vapor Deposition) reactor and the process is one of the most difficult to control and reproduce. It is not uncommon to experience periods of “bust” as the ability to overgrow a grating moves from a satisfactory to an unsatisfactory condition.

A previous attempt to form a DFB grating from InP only is described in U.S. Pat. No. 6,072,812, the contents of which are incorporated herein by reference. However, the operation of this device relies on absorption in the p-type regions formed in an n-type InP substrate, making it a loss grating. This patent states clearly that the purpose of the island regions formed within the substrate is to vary the absorption characteristics of the grating in such a way as to select a particular emission wavelength. The patent claims that the concentration of the dopant in the p-type regions is generally within the range 5×10¹⁸ to 5×10¹⁹ cm⁻³, but in reality it is not possible to produce p-type doping higher than about 7×10¹⁸ cm⁻³. This patent, though clearly describing an absorption grating, states speculatively that the conductivity type of the spaced regions could be the same as the substrate. The patent is silent as to the proposed doping concentration under such circumstances other than to imply that it must be such as to ensure the production of an absorption grating.

Absorption gratings are generally used in association with short cavity lasers, operating at low powers. They are not generally suitable for high power lasers.

An all-InP DFB grating has been previously demonstrated by Kazmerski et.al. (1995). In this structure an n-type InP grating was placed in the p-InP region and the device operation relied on the current through the p-InP cladding being blocked by the n-InP grating. This gain guided structure only operates when the current flows through the device so that the wavelength chirp is expected to be large.

### SUMMARY OF THE INVENTION

According to the present invention there is provided a distributed feedback semiconductor laser comprising an active layer for producing light; and an index grating associated with said active layer, said index grating comprising a layer of semiconductor material doped with a first dopant and having a main portion containing spaced islands of the same semiconductor material doped with a second dopant of the same conductivity type as said first dopant and at a sufficiently higher doping concentration than said main portion of said layer to change the refractive index thereof.

The present invention is based on the realization that the refractive index changes accompanying different doping concentrations of dopant of the same type in semiconductor materials can be sufficient to form an index grating within the same semiconductor material. For example, an InP grating can be formed with a heavily doped n-type InP regions, surrounded by a more lightly doped InP layer, instead of InGaAs(P) regions surrounded by an InP layer. In the case of InP, the material should be n-type because the change in refractive index for p-type InP is much smaller due to the fact that the holes have a much larger effective mass, which leads to reduced bandfilling. However, other semiconductor materials can be employed so long as changes in doping concentration result in changes in refractive index. Other examples include doped GaAs and GaN.

The second dopant does not change the absorption characteristics of the semiconductor material sufficiently to interfere with the optical properties of the index grating.

The second dopant in the spaced islands can be the same as the first dopant, although it can also be a different dopant so long as it has the same conductivity type. For example, in the case of InP semiconductor material, the low concentration material could be doped with sulfur and the high concentration material could be doped with silicon.

The change in doping concentration of the dopant in a grating in accordance with the invention does not result in a significant change in absorption characteristics such that the grating acts as a lossy grating. Instead the grating operates as an index-coupling grating relying on the change in refractive index and without the need for current flow.

Unlike the lossy grating described in U.S. Pat. No. 6,072,812, which in the illustrated embodiment relies on a different dopant to change the absorption characteristics of the semiconductor material, the present invention relies solely on the refractive index change brought about by changes in concentration of the dopant to form the grating. In the preferred embodiment the dopant for both the islands and the main portion of the grating is silicon. The applicants have found surprisingly that the dopant concentration-induced change in refractive index is sufficient to form a workable DFB laser.

In particular the DFB laser should preferably be a long cavity laser with a cavity length of at least 500 μm. In a long cavity laser, an index grating DFB laser can outperform an absorption grating laser, especially at high powers, for example in the order of 25 mW, where it becomes more important to eliminate absorption in the laser cavity.

In accordance with another aspect of the invention there is provided DFB laser, comprising forming a first layer of said semiconductor material doped at a first dopant a first doping concentration; forming a second layer of said semiconductor material over said first layer, said second layer being doped with a second dopant of the same conductivity type as said first dopant and at a second doping concentration sufficiently higher than said first doping concentration to change the refractive index of said semiconductor material without significantly changing the absorption characteristics of the semiconductor material; etching through a mask to form spaced etched regions extending at least through said second layer; and overgrowing a further layer of said semiconductor material, said further layer being doped with said first dopant at said first concentration, to form a composite layer of said semiconductor material having a main portion doped at said first concentration and containing spaced islands of different doping concentration having a different refractive index from said main portion.

The semiconductor material is preferably n-type InP, with a doping concentration in the main portion of less than about 1×10¹⁸ cm⁻³ and a doping concentration in the islands of at least about 1×10¹⁹ cm^{-3,} and preferably more than 1×10¹⁹ cm⁻³ and even more preferably greater than about 2×10¹⁹ cm⁻³. The use of the same dopant in the same material merely changes the refractive index without changing the absorption characteristics so much as to cause the grating to operate as a lossy or absorption grating. Unlike the prior art, the primary mode of operation of this grating is as an index grating, which is essentially a non-lossy grating.

### BRIEF DESCRIPTION OF THE DRAWINGS

The features and advantages of the invention will become more apparent from the following detailed description of the exemplary embodiment(s) with reference to the attached diagrams wherein:

FIG. 1 is a schematic diagram of a DFB laser structure;

FIG. 2 shows the refractive index of InP as a function of doping concentration at wavelength of 1.5 μm;

FIG. 3a is a schematic diagram of a layered substructure useful in forming an index grating;

FIG. 3b illustrates one step in the formation of an index grating;

FIG. 3c illustrates a subsequent overgrowth step in the formation of a grating;

FIG. 4 is an SSRM cross-section of a dopant-induced refractive index step DFB laser;

FIG. 5 shows the L-I (Luminance-current) characteristic of a dopant-induced refractive index DFB laser at 25° C. made in accordance with the principles of the invention.

FIG. 6 shows the spectral characteristics of a dopant-induced refractive index DFB laser at 20° C. made in accordance with the principles of the invention.

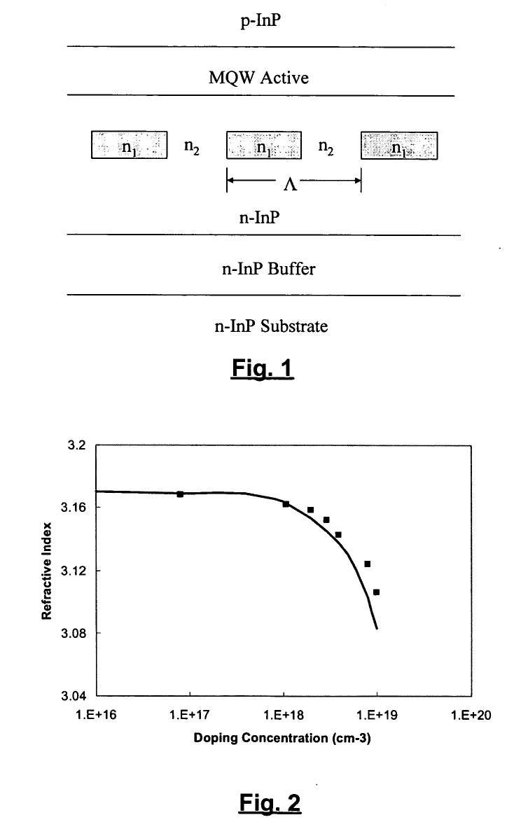

### DETAILED DESCRIPTION OF THE EMBODIMENTS

It is known to a person skilled in the art of semiconductor physics that at high carrier concentrations the refractive index of a semiconductor is reduced. The three principal carrier induced effects are due to the plasma effect, the Burstein-Moss effect and band gap shrinkage. A. R. Forouhi and I. Bloomer, in “Properties of Indium Phosphide”, INSPEC, (1991) p 126. S. Adachi, in “Physical properties of III-V Semiconductor Compounds”, Wiley (1992), p179.

These effects have been calculated for a variety of materials by Bennett et al. R. Bennett, R. A. Soref and J. Del Alamo, IEEE J QE-26, 113 (1990). They have been experimentally determined for InP. M. S. Whalen and J. Stone, J. Appl. Phys. 53 4340 (1982). Of primary importance are the measurements of carrier-induced changes at 1.5 micron wavelength. These are shown in FIG. 2, which is taken from L. Chusseau, P. Martin, C. Brasseur, C. Albert, P. Herve, P. Arguel, F. Lopez-Dupuy, and E. V. K. Rao, Appl. Phys. Lett. 69 3054 (1996). Large reductions in refractive index can be seen at high n-type doping levels in the order of about 1×10¹⁹ cm⁻³. It should be noted that the changes in p-type InP is much smaller because the holes have a much larger effective mass leading to a reduced bandfilling. Therefore, for devices which require an index step, in the case of InP, the material with the low refractive index should be n-type, although with other materials it may be possible to use p-type material.

The mathematical modelling of DFB lasers is extremely detailed and extensive. See, for example, G. P. Agrawal and N. K. Dutta, “Semiconductor Lasers”, Van Nostrand Reinhold (1986), Chapter 7.7). J. Carroll, J. Whiteaway and D. Plumb, “Distributed feedback semiconductor lasers”, IEE (1998). The following is a simplified approach.

The reflection per unit length κ is called the grating coupling factor. It is defined by the expression κ [symbol] =2ρ/Λ, where Λ is the grating period and ρ is (n₂−n₁)/(n₂+n₁). The values n₂ and n₁ are the refractive indices of the two components of the Bragg grating. For satisfactory operation of a DFB laser the κL product should be about 2, where L is the laser cavity length. From FIG. 2, at 1.5 micron, n₂=3.166 (n-doping at 5×10¹⁷ cm⁻³) and n₁=3.158 (n-doping at 2×10¹⁸ cm⁻³). Therefore with a grating pitch of 0.24 micron we have a κ [symbol] of 108 cm⁻¹ and a κL value of 2.7 for a 250 μm cavity and 38.5 μm for a 500 μm cavity. This is a low coupling value but adequate for successful DFB operation. These approximate calculations reveal that the dopant concentration-induced change in refractive index is sufficient to enable a quality DFB to be manufactured.

### EXAMPLE

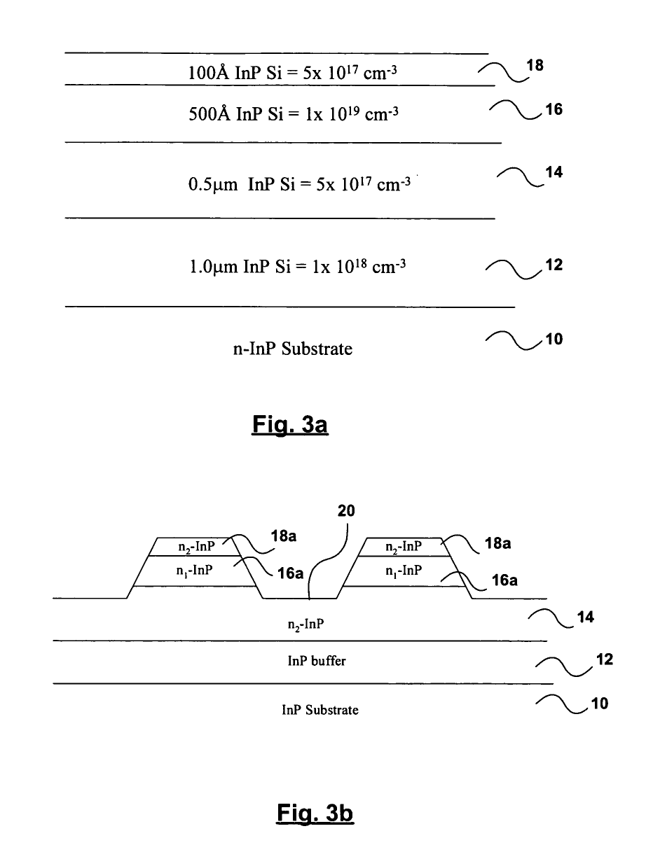

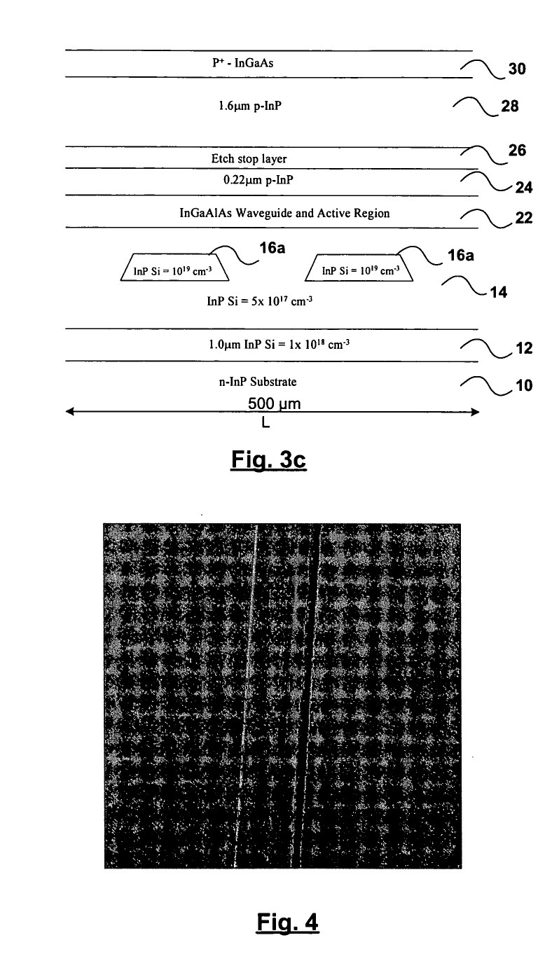

The fabrication of one example of a dopant-induced index DFB grating constructed in accordance with the principles of the invention is shown in FIGS. 3a to 3c.

First the DFB grating substructure is grown as shown in FIG. 3a. The substructure consists of a stack of layers, namely an n-InP substrate 10, a 1 μm thick InP buffer layer 12 doped with silicon at a concentration of 1×10¹⁹ cm⁻³, a 0.5 μm thick InP grating layer 14 doped with silicon at a concentration of 5×10¹⁷ cm⁻³, a 500 Å InP grating layer 16 doped with silicon at a concentration of 1×10¹⁹ cm⁻³, and a 100 Å InP cap layer 18 doped with silicon at a concentration of 5×10¹⁷.

The cap layer 18 is used to enhance the growth of a subsequent overgrowth layer, but is not essential. The grating substructure as shown in FIG. 3a is used to form the grating within a DFB laser. Although silicon is described as the dopant in this example, it will be appreciated that other suitable dopants can be used. Suitable dopants are S, Se, Sn or Te.

A periodic mask is formed on the top surface by exposing a photoresist either holographically or by electron beam lithography. After developing, the photoresist is used as a mask for etching. As shown in FIG. 3b, the etch 20 is deep enough to penetrate through the highly doped InP layer, as shown in FIG. 3b, leaving regions 16a and 18a of respective layers 16, 18.

Finally, as shown in FIG. 3c, the wafer is overgrown in an MOCVD reactor with low-doped InP, having a doping concentration of 5×10¹⁷ cm⁻³, such that the high-doped n-type InP regions 16a are embedded in the low-doped InP layer 14. The material will planarise quite quickly because the regrowth is of InP on InP.

After growth of a spacer region above the highly doped regions 16a, the remaining portion of the DFB laser is grown in a conventional manner as shown in FIG. 3c. This consists of an active region 22, which in this example is InGaAlAs, a 0.22 μm p-InP layer 24, an etch stop layer 24, a 1.6 μm p-InP layer 28, and a p+ InGaAs top layer 30.

The length L of the laser cavity (from side to side in the FIGS. 3a to 3c) is at least 500 μm. A high performance index grating DFB laser can be much using such a cavity.

Experimental Details

The growths were performed on INP:S substrates with an AIX 2400 multiwafer MOCVD reactor in an 8×3 inch configuration. The precursors were TMI (trimethylindium), TMG (trimethylgallium), TMA (trimethylaluminum), arsine, phosphine, silane and DEZ (diethylzinc). The reactor pressure was 100 mbar and the total hydrogen flow was 35 l/min. Single layers of heavily doped InP:Si, grown on InP:Fe substrates exhibited Hall effect electron mobilities of 1080 cm²V⁻¹s⁻¹ at a doping concentration of 1.2×10¹⁹ cm⁻³ at room temperature.

The first MOCVD growth took place at 650° C. and consisted of the 1 μm InP buffer 12 (1×10¹⁸ cm⁻³), 0.5 μm of InP 14 (5×10¹⁷ cm⁻³), 500 Å n⁺⁺-InP grating layer 16 (1×10¹⁹ cm⁻³) and a 100 Å InP cap layer 18(5×10¹⁷ cm⁻³).

The first order holographic DFB gratings, with a pitch of 241 nm, were chemically etched to a depth of ˜950 Å with a Matech WaveEtch tool (FIG. 3b). The second MOCVD growth (FIG. 3c) consisted of an infill of InP (5×10¹⁷ cm⁻³), a 500 Å InP spacer layer (5×10¹⁷ cm⁻³), a 900 Å InGaAlAs graded waveguide 22, an InGaAlAs/InGaAlAs strained layer multi-quantum well active region, a 900 Å InGaAlAs graded waveguide, a 0.22 μm p-InP, a thin etch stop layer 26, 1.6 μm p-InP layer 28 and a p⁺-InGaAs contact layer 30. The growth initiation temperature was 625° C., the remaining layers were grown at 650° C. except for the Aluminium containing layers, which were grown at 700° C. to minimise oxygen incorporation.

SEM and TEM cross-section analysis did not reveal the grating. Scanning Spreading Resistance Microscopy (SSRM), which is a cross sectional scanning probe technique that is sensitive to dopant concentrations, was utilized. The SSRM measurements were performed using a commercial instrument (DI Veeco, Dimension 3100), equipped with the appropriate SSRM applications module. Conductive diamond coated probes were used (DI Veeco, DDESP). The probe-sample bias voltage was set to +1.0 V for the SSRM measurements.

500 μm long, 2 μm wide, ridge waveguide lasers with HR/AR coated facets were fabricated and tested in bar form.

Grating preservation was confirmed by the SSRM cross-section shown in FIG. 4. The grating can be seen quite clearly, there is no evidence of grating degradation and the planarization is good.

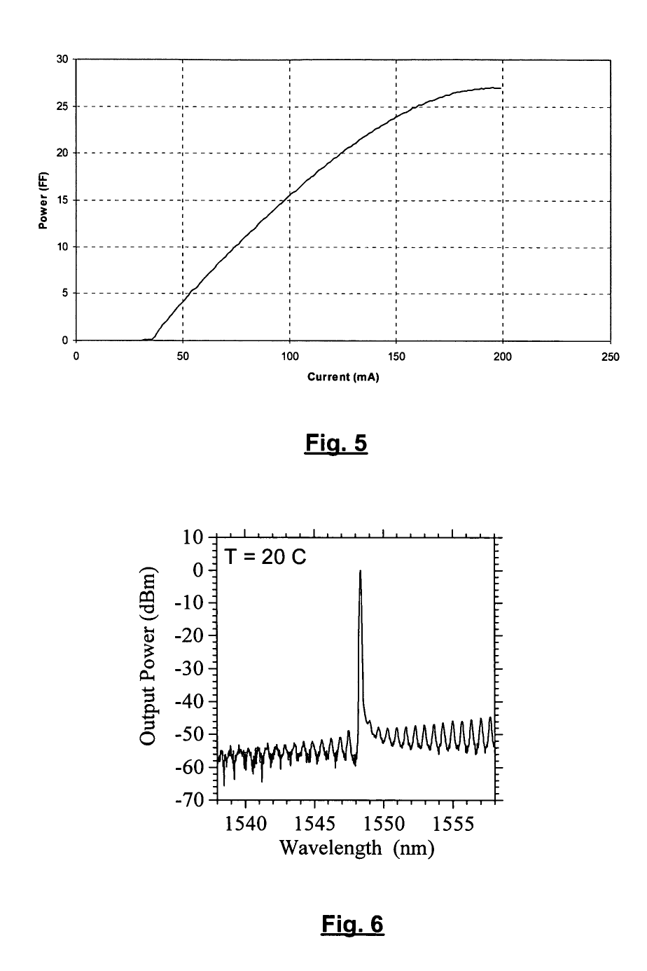

The L-I characteristic shown in FIG. 5 shows a threshold current of 45 mA, efficiencies of >0.3 W/A and power levels in excess of 25 mW. The spectral characteristic, shown in FIG. 6, shows a single mode peak at 1.55 μm with a SMSR >45 dB. The gain peak from the active region was centred at ˜1.57 μm. κL is lower than a conventional DFB laser so is well suited for long cavity applications.

The grating is different from the conventional structure because the (heavily doped) n⁺⁺-InP has a lower refractive index than the surrounding InP whereas InGaAs(P) has a higher refractive index.

There are several advantages of the dopant grating. Firstly, it is easier to control and reproduce the thickness, doping concentration and uniformity of InP than it is the thickness, composition and uniformity of InGaAs(P). The κL can be adjusted without affecting any other laser parameter by changing the doping concentration in the grating layer. Because the exposed grating surface is only InP it is less susceptible to degradation from regrowth than a surface with a mixed composition. The grating is easier to etch because there is only one material with one etch rate rather than two materials with two different etch rates.

The grating is likely to be more uniform and reproducible because it is constructed from a single material.

Grating preparation, or pre-clean, is much easier, more reliable and reproducible because the surface to be cleaned does not contain a mixture of materials.

Thermal characteristics of a laser with a dopant grating are superior to a conventional device because the thermal resistance of InP is much lower than that of InGaAs(P).

The dopant grating can only be used for applications where weak gratings (low κL [symbol] ) are required.

While there is some absorption in the n⁺⁺-InP grating layer (˜10 cm−1), it is much lower than absorption from the p-InP (˜50 cm−1), and significantly lower than that of InGaAs or InGaAsP. See, S. Adachi, in “Physical properties of III-V Semiconductor Compounds”, Wiley (1992), p179.

The operation of the above dopant grating has been demonstrated with InGaAlAs/InGaAlAs material in the active region. The inventors expect that it would perform with, for example, InGaAsP/InGaAsP or equivalent materials in the active region.

A new type of DFB laser has been demonstrated in which the new grating material design consists only of InP and utilises the change in refractive index of InP with doping concentrations. The new design is an improvement on the traditional structure, which requires epitaxial growth over a mixed surface crystal surface. However, the new dopant-induced refractive index step DFB laser has a low κL which means that it is only suitable for long cavity lengths. 500 μm long cavity lasers have been fabricated which exhibit single mode operation with a SMSR of over 45 dB.

The embodiments presented are exemplary only and persons skilled in the art would appreciate that variations to the above described embodiments may be made without departing from the spirit of the invention. The scope of the invention is solely defined by the appended claims.

All references are herein incorporated by reference.

1. A distributed feedback semiconductor laser comprising:
a. an active layer for producing light; and
b. an index grating associated with said active layer, said index grating comprising a layer of semiconductor material doped with a first dopant and having a main portion containing spaced islands of the same semiconductor material doped with a second dopant of the same conductivity type as said first dopant and at a sufficiently higher doping concentration than said main portion of said layer to change the refractive index thereof.

2. A distributed feedback semiconductor laser as claimed in claim 1, wherein said first and second dopants are the same.

3. A distributed feedback semiconductor laser as claimed in claim 1 wherein said semiconductor material is InP.

4. A distributed feedback semiconductor laser as claimed in claim 3, wherein said semiconductor material is n-type InP.

5. A distributed feedback semiconductor laser as claimed in claim 4, wherein said n-type InP is doped with silicon.

6. A distributed feedback semiconductor laser as claimed in claim 5, wherein the doping concentration of said main portion is less than about 1×10¹⁸ cm⁻³, and the doping concentration of said spaced islands is at least about 1×10¹⁹ cm⁻³.

7. A distributed feedback semiconductor laser as claimed in claim 5, wherein the doping concentration of said main portion is about 5×10¹⁷ cm⁻³, and the doping concentration of said spaced islands is about 1×10¹⁹ cm⁻³.

8. A distributed feedback semiconductor laser as claimed in claim 1, wherein said laser has a cavity length of at least 500 μm.

9. A distributed feedback semiconductor laser as claimed in claim 8, wherein said laser has a power of at least 25 mW.

10. A distributed feedback semiconductor laser as claimed in claim 1, wherein said active layer comprises an InGaALAs.InGaAlAs strained layer.

11. A method of making a grating substructure in semiconductor material for use in a DFB laser, comprising:
a. forming a first layer of said semiconductor material doped at a first dopant a first doping concentration;
b. forming a second layer of said semiconductor material over said first layer, said second layer being doped with a second dopant of the same conductivity type as said first dopant and at a second doping concentration sufficiently higher than said first doping concentration to change the refractive index of said semiconductor material without significantly changing the absorption characteristics of the semiconductor material;
c. etching through a mask to form spaced etched regions extending at least through said second layer; and
d. overgrowing a further layer of said semiconductor material, said further layer being doped with said first dopant at said first concentration, to form a composite layer of said semiconductor material having a main portion doped at said first concentration and containing spaced islands of different doping concentration having a different refractive index from said main portion.

12. A method as claimed in claim 11, wherein said first and second dopants are the same.

13. A method as claimed in claim 11, wherein said etch is continued at least partially into said first layer.

14. A method as claimed in claim 11, further comprising forming a cap layer of said semiconductor material over said second layer prior to applying said mask, and performing said etch through at least said cap layer and said second layer, said cap layer being doped with said dopant at the same doping concentration as said first layer.

15. A method as claimed in claim 14, wherein said semiconductor material is n-type InP.

16. A method as claimed in claim 15, wherein said first and second dopants are silicon.

17. A method as claimed in claim 16, wherein the doping concentration of said first layer is less than about 1×10¹⁸ cm⁻³, and the doping concentration of said second layer is at least about 1×10¹⁹ cm⁻³.

18. A method as claimed in claim 16, wherein the doping concentration of said first layer is about 5×10^{17 cm}⁻³, and the doping concentration of said second layer is about 1×10¹⁹ cm⁻³.

19. An index grating for a distributed feedback seminconductor laser comprising a semiconductor material doped with a first dopant and having a main portion containing spaced islands of the same semiconductor material doped with a second dopant of the same conductivity type as said first dopant and at a sufficiently higher doping concentration than said main portion of said layer to change the refractive index thereof.

20. An index grating as claimed in claim 19, wherein said first and second dopants are the same.

21. An index grating as claimed in claim 20, wherein said first and second dopants are different.
